(19) United States
(12) Patent Application Publication
(10) Pub. No.: US 2023/0103537 A1
(43) Pub. Date: Apr. 6, 2023

(54) COMMUNICATION SYSTEM, NETWORK RELAY DEVICE, NETWORK RELAY METHOD, AND PROGRAM

(71) Applicant: Nippon Telegraph and Telephone Corporation, Tokyo (JP)

(72) Inventors: Hideki MAEDA, Musashino-shi, Tokyo (JP); Hiroto TAKECHI, Musashino-shi, Tokyo (JP); Katsuhiro ARAYA, Musashino-shi, Tokyo (JP); Masatoshi NAMIKI, Musashino-shi, Tokyo (JP); Yasutaka SUGANO, Musashino-shi, Tokyo (JP); Masahiro YOKOTA, Musashino-shi, Tokyo (JP)

(21) Appl. No.: 17/802,437

(22) PCT Filed: Feb. 27, 2020
(86) PCT No.: PCT/JP2020/007984

§ 371 Date: Aug. 25, 2022

(51) Int. Cl. H04L 47/41

(52) U.S. Cl. CPC H04L 47/41

(57) ABSTRACT

A communication system includes counter devices forming a pair and a plurality of switch devices, which are network relay devices connecting the counter devices. A traffic bypass unit of each of the switch devices transmits a part of traffic of a multi-chassis link-aggregation group to the other switch device via a bridge port when a traffic amount per effective communication port in the own device is larger than a traffic amount per effective communication port in the other switch device by a threshold or more in the multi-chassis link-aggregation group.

### TECHNICAL FIELD

The present invention relates to a communication system, a network relay device, a network relay method, and a program to which a multi-chassis link-aggregation (MC-LAG) function is applied.

### BACKGROUND ART

In recent years, for the purpose of a reduction in network cost, it has been examined to utilize, in a carrier network, a box-type switch widely spread in the data center (DC) market. As means for improving fault tolerance of the box-type switch, there is the multi-chassis link-aggregation technique.

General multi-chassis link-aggregation is used in an “Act/Sby configuration” for loop avoidance or the like of a part of frames (broadcast frames). In the “Act/Sby configuration”, only one of a plurality of relay devices configuring the multi-chassis link-aggregation can transmit a frame to a counter device.

On the other hand, as a method of improving link use efficiency of a network, an “Act/Act configuration” in which all the relay devices are capable of transmitting frames to the counter device has been examined.

For example, Patent Literature 1 described below describes a network device including two counter device connection ports connected to two counter devices having a link-aggregation function, a state monitor unit that monitors a state of failure occurrence of the own device and other network devices, and a frame transfer unit that, when the state monitor unit detects a failure of a physical link in the own device, transmits a frame received from the counter device from a network device connection port to a first SW and, when the state monitor unit does not detect a failure in the own device, transfers the frame received from the counter device to the counter device and does not transfer the frame to the counter device through the first SW. In this technique, the “Act/Act configuration” that does not perform double distribution to the counter device while enabling frame transmission from all network devices configuring multi-chassis link-aggregation to the counter device is realized by only network devices of layer 2.

FIG. 9 and FIG. 10 are diagrams showing the configuration of the multi-chassis link-aggregation communication system having the Act/Act configuration in the related art.

A communication system 90 includes a plurality of switch devices (a first switch device (SW1) 92 and a second switch device (SW2) 94), which are network relay devices, and two counter devices (a first counter device 96 and a second counter device 98).

It is assumed that frames are transmitted from the first counter device 96 to the second counter device 98 as indicated by arrows in FIG. 9.

Each of the switch devices 92 and 94 includes a reception port RP connected to the first counter device 96 and a transmission port SP connected to the second counter device 98. Each of the switch devices 92 and 94 includes a bridge port BP connected to the other switch.

Each of the counter devices 96 and 98 includes a first port P1 connected to the first switch device 92 and a second port P2 connected to the second switch device 94.

In a logical connection configuration of the communication system 90, the first port P1 and the second port P2 of the first counter device 96 are virtually regarded as one port (LAG1) by applying the link-aggregation function to the first port P1 and the second port P2 and the first port P1 and the second port P2 of the second counter device 98 are virtually regarded as one port (LAG2) by applying the link-aggregation function to the first port P1 and the second port P2. The reception port RP of the first switch device 92 and the reception port RP of the second switch device 94 are virtually regarded as one port of one device (MC-LAG1) by applying the multi-chassis link-aggregation function to the reception ports RP and the transmission port SP of the first switch device 92 and the transmission port SP of the second switch device 94 are virtually regarded as one port of one device (MC-LAG2) by applying the multi-chassis link-aggregation function to the transmission ports SP.

When the communication system 90 is normally operating, as shown in FIG. 9, the bridge ports BP Of the switch devices 92 and 94 are closed. This is to avoid the transmitted frames looping.

In FIG. 9, a frame transmitted from the first port P1 of the first counter device 96 is received by the reception port RP of the first switch device 92 and transmitted from the transmission port SP of the first switch device 92 to the first port P1 of the second counter device 98. A frame transmitted from the second port P2 of the first counter device 96 is received by the reception port RP of the second switch device 94 and transmitted from the transmission port SP of the second switch device 94 to the second port P2 of the second counter device 98.

On the other hand, when a failure occurs in the communication system 90, for example, when a failure occurs in the transmission port SP of the first switch device 92 as shown in FIG. 10, the closing of the bridge ports BP of the switch devices 92 and 94 is released in order to bypass the frames.

In FIG. 10, a frame transmitted from the first port P1 of the first counter device 96 is received by the reception port RP of the first switch device 92 and, thereafter, transferred to the second switch device 94 via the bridge port BP. At this time, the first switch device 92 includes, in the frame to be transferred, an identifier of a port (in the example shown in FIG. 10, the first port P1) that receives the frame.

The second switch device 94 receiving the transferred frame refers to the identifier of the reception port included in the frame and determines a transmission destination of the frame. That is, the second switch device 94 transmits the frame without including, in the transmission destination, a port (in the example shown in FIG. 10, the reception port RP of the second switch device 94) in which the same multi-chassis link-aggregation (in the example shown in FIG. 10, MC-LAG1) as multi-chassis link-aggregation of the reception port is set. That is, the frame is transmitted from the transmission port SP of the second switch device 94 to the second port P2 of the second counter device 98.

In the communication system to which the multi-chassis link-aggregation is applied in this way, communication between the counter devices is enabled even at failure occurrence.

### CITATION LIST

### Patent Literature

Patent Literature 1: Japanese Patent Laid-Open No. 2018-42180

### SUMMARY OF THE INVENTION

### Technical Problem

A communication system in which the ports connecting the switches and the counter devices are expanded to pluralities of ports is examined as shown in FIG. 11.

A communication system 110 shown in FIG. 11 includes a plurality of switches (a first switch (SW1) 112 and a second switch (SW2) 114), which are network relay devices, and two counter devices (a first counter device 116 and a second counter device 118).

Each of the switch devices 112 and 114 includes two reception ports RP connected to the first counter device 116 and two transmission ports SP connected to the second counter device 118. That is, each of the switch devices 112 and 114 includes reception ports RP1 and RP2 and transmission ports SP1 and SP2. Each of the switch devices 112 and 114 includes the bridge port BP connected to the other switch.

Each of the counter devices 116 and 118 includes two ports connected to the first switch device 112 and two ports connected to the second switch device 114. That is, each of the counter devices 116 and 118 includes four ports in total including ports P1 and P2 connected to the first switch device 112 and ports P3 and P4 connected to the second switch device 114.

A case in which a failure occurs in the communication system 110 having such a configuration, specifically, a case in which a failure occurs in the transmission port SP1 of the first switch device 112, for example, as shown in FIG. 11, is examined.

When the related art is applied to a state of such a single failure, the closing between the bridge ports BP is not released. Therefore, all of frames received by the reception ports RP1 and RP2 of the first switch device 112 are transmitted from the transmission port SP2 of the first switch device 112 to the second counter device 118. There is a problem in that congestion easily occurs because of unbalance of traffic.

A configuration in which the first switch device 112 further includes a reception port RP3 and a port P1 of a third counter device 119 is connected to the reception port RP3 (a configuration in which a plurality of devices are connected to the first switch device 112), for example, as shown in FIG. 12, is examined.

When the related art is applied to such a configuration, all of frames received by the reception ports RP1 to RP3 of the first switch device 112 are transmitted from the transmission port SP1 or SP2 of the first switch device 112 to the second counter device 118. Accordingly, traffic sometimes concentrates on a part of the ports (in the example shown in FIG. 12, the transmission port SP1) of the first switch device 112. There is a problem in that congestion easily occurs because of such unbalance.

The present invention has been devised in view of such points. An object of the present invention is to reduce unbalance of traffic and prevent congestion in a multi-chassis link-aggregation communication system having an Act/Act configuration in which a relay device includes a plurality of ports.

### Means for Solving the Problem

A communication system according to the present invention is a communication system including: counter devices forming a pair; and a plurality of network relay devices connecting the counter devices. Each of the network relay devices includes: a plurality of communication ports provided for each of the counter devices and connecting the own network relay device and the counter device; a bridge port connected to another network relay device; a traffic totalization unit that totalizes, for each of multi-chassis link-aggregation groups set for the communication ports, a traffic amount received by the communication ports of the own network relay device; a failure detection unit that detects whether the communication port of the own network relay device to be a transmission destination of traffic of the multi-chassis link-aggregation group is effective; an other-device-information acquisition unit that acquires a traffic amount for each of multi-chassis link-aggregation groups in the other network relay device and information concerning whether the communication port of the other network relay device is effective; and a traffic bypass unit that transmits a part of the traffic of the multi-chassis link-aggregation group to the other network relay device via the bridge port when a traffic amount per effective communication port in the own network relay device is larger than the traffic amount per the effective communication port in the other network relay device by a threshold or more in the multi-chassis link-aggregation group.

### Effects of the Invention

According to the present invention, it is possible to reduce unbalance of traffic and prevent congestion in a multi-chassis link-aggregation communication system having an Act/Act configuration in which a relay device includes a plurality of ports.

### BRIEF DESCRIPTION OF DRAWINGS

FIG. 1 is a diagram showing an overall configuration of a communication system according to an embodiment of the present invention.

FIG. 2 is a block diagram showing a functional configuration of a switch device.

FIG. 3 is an explanatory diagram showing an example of content of a state management database.

FIG. 4 is a diagram schematically showing a data flow in the case in which a failure occurs in the communication system.

FIG. 5 is a diagram schematically showing a header portion of a bypass traffic.

FIG. 6 is a flowchart showing a procedure of reception traffic processing by the switch device.

FIG. 7 is a flowchart showing a procedure of bypass traffic processing by the switch device.

FIG. 8 is a diagram showing an example of a hardware configuration of the switch device according to the embodiment.

FIG. 9 is a diagram showing the configuration of a multi-chassis link-aggregation communication system having an Act/Act configuration in related art.

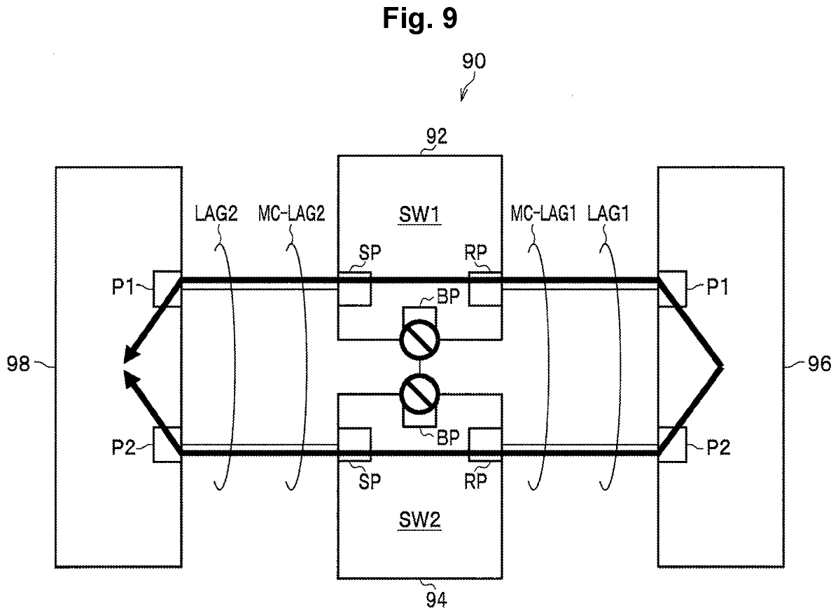

FIG. 10 is a diagram showing the configuration of the multi-chassis link-aggregation communication system having the Act/Act configuration in the related art.

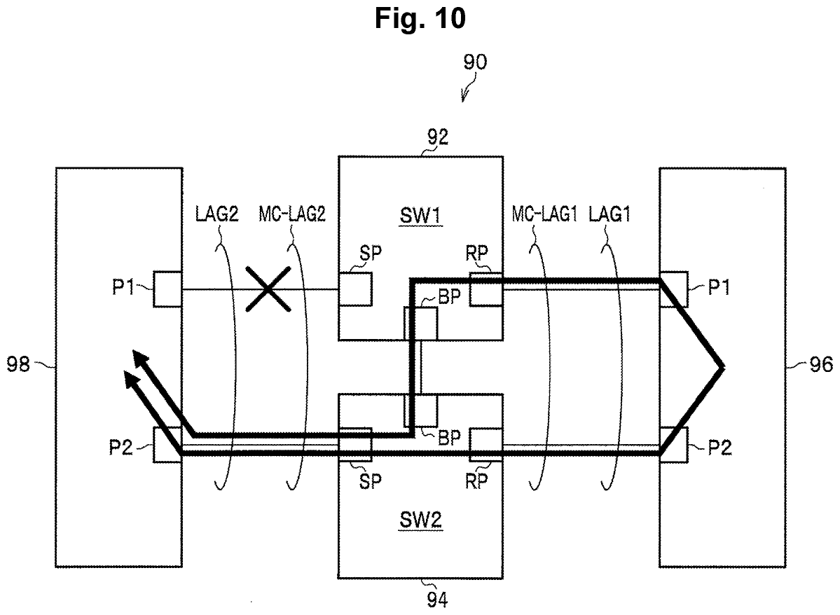

FIG. 11 is a diagram showing the configuration of the multi-chassis link-aggregation communication system having the Act/Act configuration in the related art.

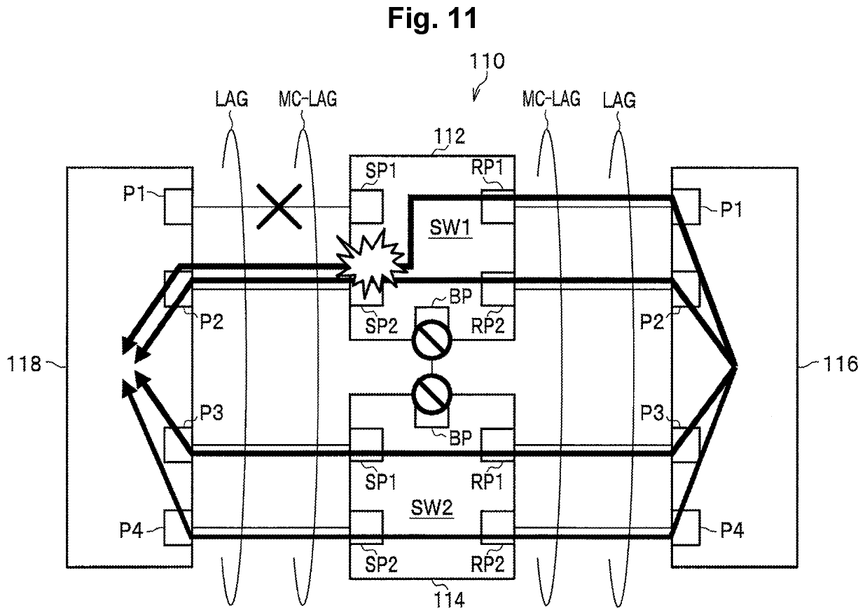

FIG. 12 is a diagram showing the configuration of the multi-chassis link-aggregation communication system having the Act/Act configuration in the related art.

### DESCRIPTION OF EMBODIMENTS

### Embodiment

Subsequently, a mode for carrying out the present invention (hereinafter referred to as “this embodiment”) is explained.

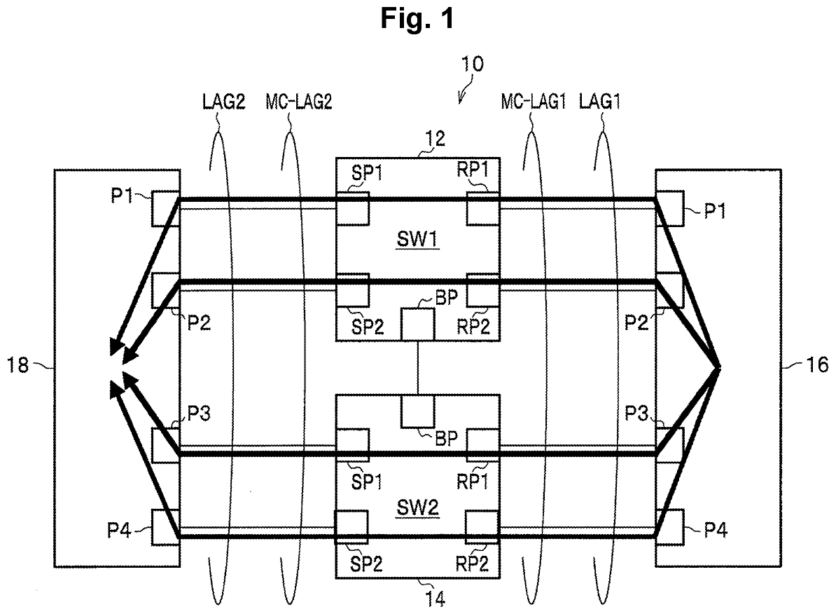

First, a communication system 10 according to an embodiment of the present invention is explained with reference to FIG. 1.

FIG. 1 is a diagram showing an overall configuration of the communication system 10 according to the embodiment of the present invention.

The communication system 10 includes a plurality of switch devices (a first switch device (SW1) 12 and a second switch device (SW2) 14), which are network relay devices, and a plurality of counter devices (a first counter device 16 and a second counter device 18). That is, the communication system 10 includes the counter devices 16 and 18 forming a pair and a plurality of network relay devices (the switch devices 12 and 14) connecting the counter devices 16 and 18.

In this embodiment, a case in which frames are transmitted from the first counter device 16 to the second counter device 18 as indicated by arrows in FIG. 1 is examined.

Each of the switch devices 12 and 14 includes two reception ports RP connected to the first counter device 16 and two transmission ports SP connected to the second counter device 18. That is, each of the switch devices 12 and 14 includes reception ports RP1 and RP2 and transmission ports SP1 and SP2. Each of the switch devices 12 and 14 includes a bridge port BP connected to the other switch.

That is, each of the network relay devices (the switch devices 12 and 14) includes a plurality of communication ports (the reception ports RP1 and RP2 and the transmission ports SP1 and SP2) provided for each of the counter devices 16 and 18 and connecting the own network relay device (hereinafter referred to as “own device”) and the counter devices 16 and 18 and the bridge port BP connected to the other network relay device.

Note that, in this embodiment, in order to examine a case in which frames are transmitted from the first counter device 16 to the second counter device 18, ports connected to the first counter device 16 in the switch devices 12 and 14 are referred to as “transmission ports” and ports connected to the second counter device 18 in the switch devices 12 and 14 are referred to as “reception ports”. However, when frames are transmitted from the second counter device 18 to the first counter device 16, the ports connected to the second counter device 18 in the switch devices 12 and 14 function as the “transmission ports” and the ports connected to the first counter device 16 in the switch devices 12 and 14 function as the “reception ports”.

Each of the counter devices 16 and 18 includes two ports connected to the first switch device 12 and two ports connected to the second switch device 14. That is, each of the counter devices 16 and 18 includes four ports in total including ports P1 and P2 connected to the first switch device 12 and ports P3 and P4 connected to the second switch device 14.

In a logical connection configuration of the communication system 10, the ports P1 to P4 of the first counter device 16 are virtually regarded as one port (LAG1) by applying a link-aggregation function to the ports P1 to P4 and the ports P1 to P4 of the second counter device 18 are virtually regarded as one port (LAG2) by applying the link-aggregation function to the ports P1 to P4. The reception ports RP1 and RP2 of the first switch device 12 and the reception ports RP1 and RP2 of the second switch device 14 are virtually regarded as one port of one device (MC-LAG1) by applying a multi-chassis link-aggregation function to the reception ports RP1 and RP2 and the transmission ports SP1 and SP2 of the first switch device 12 and the transmission ports SP1 and SP2 of the second switch device 14 are virtually regarded as one port of one device (MC-LAG2) by applying the multi-chassis link-aggregation function to the transmission ports SP1 and SP2.

In FIG. 1, a frame transmitted from the first port P1 of the first counter device 16 is received by the reception port RP1 of the first switch device 12 and transmitted from the transmission port SP1 or the transmission port SP2 (in FIG. 1, the transmission port SP1) of the first switch device 12 to a port (in FIG. 1, the port P1) of the second counter device 18 connected to the port. A frame transmitted from the first port P2 of the first counter device 16 is received by the reception port RP2 of the first switch device 12 and transmitted from the transmission port SP1 or the transmission port SP2 (in FIG. 1, the transmission port SP2) of the first switch device 12 to a port (in FIG. 1, the port P2) of the second counter device 18 connected to the port.

A frame transmitted from the third port P3 of the first counter device 16 is received by the reception port RP1 of the second switch device 14 and transmitted from the transmission port SP1 or the transmission port SP2 (in FIG. 1, the transmission port SP1) of the second switch device 14 to a port (in FIG. 1, the port P3) of the second counter device 18 connected to the port. A frame transmitted from the fourth port P4 of the first counter device 16 is received by the reception port RP2 of the second switch device 14 and transmitted from the transmission port SP1 or the transmission port SP2 (in FIG. 1, the transmission port SP2) of the second switch device 14 to a port (in FIG. 1, the port P4) of the second counter device 18 connected to the port.

It is determined according to traffic amounts of the ports at every time which transmission ports are used when frames are transmitted from the switch devices 12 and 14 to the counter devices.

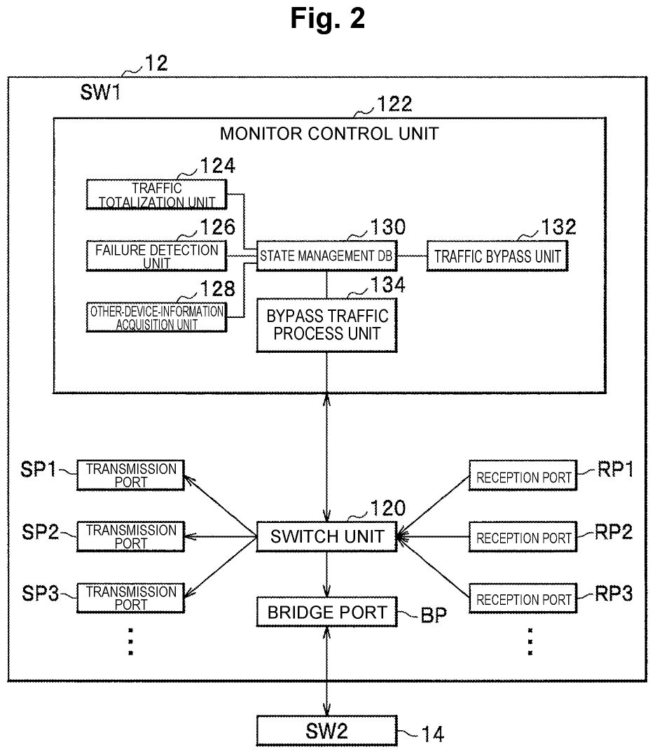

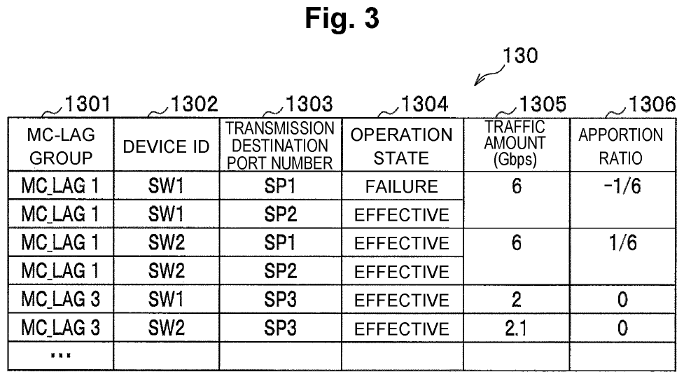

Note that, although not shown, the switch devices 12 and 14 may further include pluralities of ports and three or more counter devices may be connected to the switch devices 12 and 14. In this embodiment, as shown in, for example, lower parts of FIG. 2 and FIG. 3, the switch devices 12 and 14 further include reception ports RP3 connected to a not-shown third counter device and transmission ports SP3 connected to a not-shown fourth counter device. The reception ports RP3 of the switch devices 12 and 14 are virtually regarded as one port of one device (MC-LAG3) by applying the multi-chassis link-aggregation function to the reception ports RP3. The transmission ports SP3 of the switch devices 12 and 14 are virtually regarded as one port of one device (MC-LAG4) by applying the multi-chassis link-aggregation function to the transmission ports SP3.

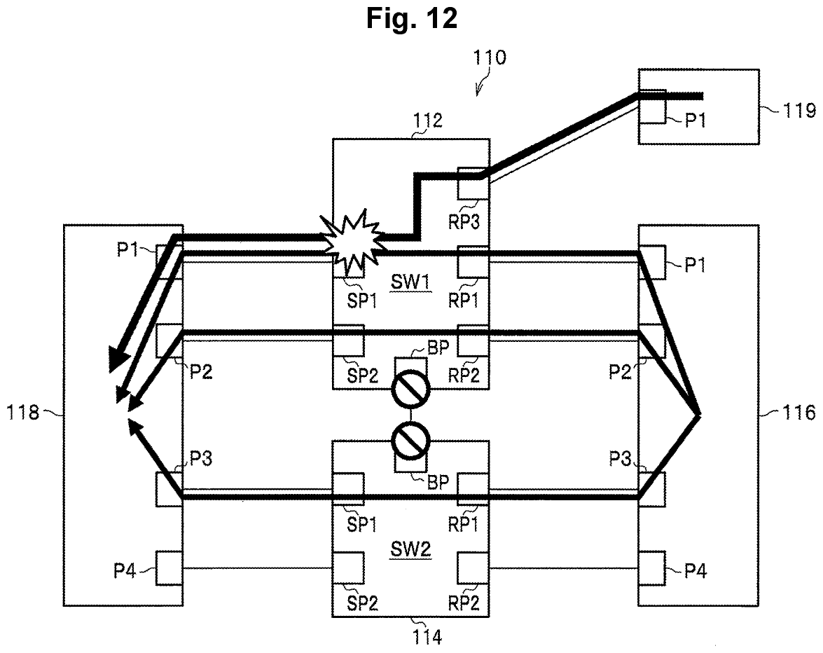

This embodiment is also applicable to a case in which the number of counter devices on a transmission side and the number of counter devices on a reception side are different and a case in which the number of ports of the counter device on the transmission side and the number of ports of the counter device on the reception side are different as shown in FIG. 12.

Subsequently, a functional configuration of the switch devices 12 and 14 is explained.

FIG. 2 is a block diagram showing a functional configuration of a switch device. In FIG. 2, the first switch device 12 is shown as an example. However, the second switch device 14 has the same configuration as the first switch device 12.

The first switch device 12 includes a switch unit 120 and a monitor control unit 122 besides the reception ports RP1, RP2, . . . , the transmission ports SP1, SP2, . . . , and the bridge port BP connected to the other switch device (in FIG. 1, the second switch device 14).

Note that, in the following explanation, it is assumed that the first switch device 12 includes two reception ports RP1 and RP2 and includes two transmission ports SP1 and SP2.

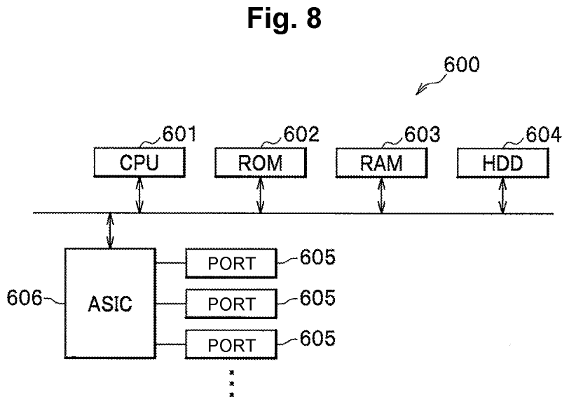

The switch unit 120 is specifically an ASIC (Application Specific Integrated Circuit) 606 (see FIG. 8). Frames received by the reception ports RP1 and RP2 are transmitted from one of the transmission ports SP1 and SP2.

The monitor control unit 122 monitors and controls a transfer state of the frames in the switch unit 120.

The monitor control unit 122 includes a traffic totalization unit 124, a failure detection unit 126, an other-device-information acquisition unit 128, a state management database (DB) 130, a traffic bypass unit 132, and a bypass-traffic process unit 134.

The traffic totalization unit 124 totalizes, for each of multi-chassis link-aggregation groups set for the communication ports of the own device, a traffic amount received by the communication ports.

Specifically, the traffic totalization unit 124 totalizes, as a total traffic amount of MC-LAG1, a sum of a traffic amount received by the reception port RP1 in a predetermined period and a traffic amount received by the reception port RP2 in the predetermined period.

The traffic totalization unit 124 records the totalized traffic amounts of the multi-chassis link-aggregation groups in the state management database 130 explained below.

The failure detection unit 126 detects whether communication ports of the own device to be transmission destinations of traffic of the multi-chassis link-aggregation group are effective.

For example, when the traffic can be normally transmitted from the transmission ports SP1 and SP2 of the own device, which are transmission destinations of MC-LAG1, the failure detection unit 126 determines that the transmission ports SP1 and SP2 are effective (have no failure). On the other hand, when the traffic cannot be normally transmitted from the transmission port SP1 or SP2 of the own device, the failure detection unit 126 determines that the transmission port SP1 or SP2 is not effective (is out of order).

Note that a failure of the transmission port SP in this embodiment indicates a state in which transmission of traffic from the transmission port SP cannot be normally performed and includes, for example, besides a failure of the transmission port SP itself, a failure of the communication ports of the counter devices 16 and 18 and a failure of a connection line between the communication ports.

The failure detection unit 126 records presence or absence of a failure of each of the communication ports of the own device (whether the communication port is effective) in the state management database 130 explained below.

The other-device-information acquisition unit 128 acquires a traffic amount for each of the multi-chassis link-aggregation groups in the other network relay device, in this embodiment, the second switch device 14 and information concerning whether the communication ports of the second switch device 14 are effective.

The other-device-information acquisition unit 128 acquires a total traffic amount for each of the multi-chassis link-aggregation groups and an operation state of the communication ports in the second switch device 14 from the traffic totalization unit 124 and the failure detection unit 126 (both of which are not shown) of the second switch device 14 via, for example, the bridge port BP.

Alternatively, the other-device-information acquisition unit 128 may read out a traffic amount for each of link-aggregation groups in the second switch device 14 and presence or absence of a failure on a link from, for example, the state management database 130 of the second switch device 14.

The other-device-information acquisition unit 128 records acquired information concerning the second switch device 14 in the state management database 130 explained below.

The state management database 130 stores the traffic amount totalized by the traffic totalization unit 124, the presence or absence of a failure detected by the failure detection unit 126, the information concerning the second switch device 14 acquired by the other-device-information acquisition unit 128, and the like.

FIG. 3 is an explanatory diagram showing an example of content of the state management database.

The state management database 130 shown in FIG. 3 includes an identifier 1301 of a multi-chassis link-aggregation group, an identifier (a device ID) 1302 for identifying a switch device, a transmission destination port number 1303 of traffic of the multi-chassis link-aggregation group, operation state information 1304, traffic amount information 1305, and apportion ratio information 1306.

In the identifier 1301 of the multi-chassis link-aggregation group, identifiers for identifying multi-chassis link-aggregation groups set for the communication ports of the switch devices 12 and 14 are recorded. In this embodiment, in order to examine traffic transmitted from the first counter device 16 to the second counter device 18, in FIG. 3, MC-LGA1 set for the reception ports RP1 and RP2 of the switch devices 12 and 14 is shown.

In FIG. 3, information concerning MC-LAG3 set for the not-shown third reception ports RP3 of the switch devices 12 and 14 is also shown.

In the device identifier 1302, “SW1” is stored as an identifier of the first switch device 12 and “SW2” is stored as an identifier of the second switch device 14.

In the transmission destination port number 1303, an identifier (a port number) of a communication port to be a transmission destination of traffic of the multi-chassis link-aggregation group indicated by the identifier 1301 is stored.

In FIG. 3, identifiers SP1 and SP2 of the transmission ports of the switch devices 12 and 14 are stored as transmission destination ports of traffic received by MC-LAG1. An identifier SP3 of the transmission ports of the switch devices 12 and 14 is stored as a transmission destination port of traffic received by MC-LAG3.

In the operation state information 1304, an operation state (presence or absence of a failure) of the communication port identified by the transmission destination port number 1303 is recorded.

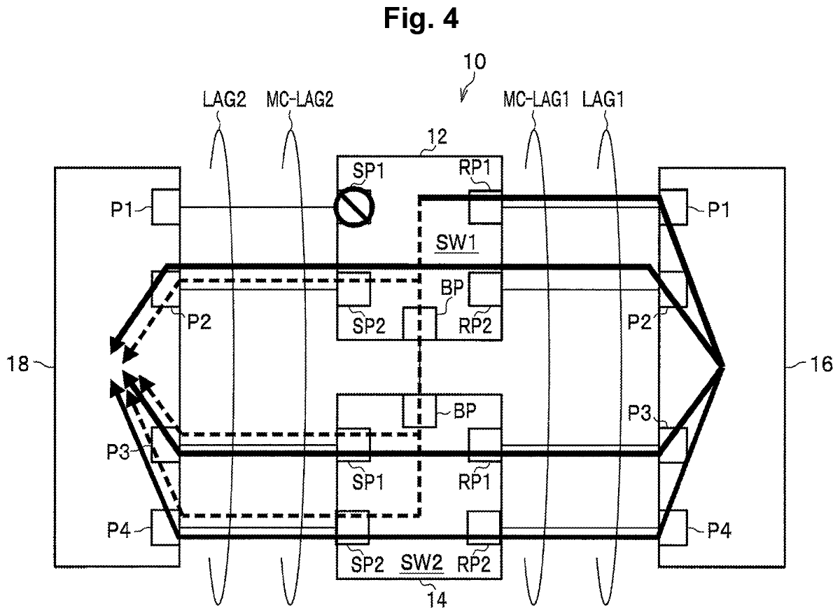

In the example shown in FIG. 3, a failure is detected in the transmission port SP1 of the first switch device 12. That is, as shown in FIG. 4, communication between the transmission port SP1 of the first switch device 12 and the port P1 of the second counter device 18 is impossible. The remaining transmission ports SP are effective.

In the following explanation, a transmission port in which a failure is detected is referred to as “failure communication port” and a transmission port in which a failure is not detected is referred to as “effective communication port”.

In the traffic amount information 1305, a traffic amount in a predetermined period for each of the link-aggregation groups totalized by the traffic totalization unit 124 is recorded.

In the example shown in FIG. 3, a total traffic amount of MC-LAG1 of the first switch device 12 (SW1) is 6 Gbps and a total traffic amount of MC-LAG1 of the second switch device 14 (SW2) is 6 Gbps. A total traffic amount of MC-LAG3 of the first switch device 12 is 2 Gbps and a total traffic amount of MC-LAG3 of the second switch device 14 is 2.1 Gbps.

In the apportion ratio information 1306, an apportion ratio for traffic to the other relay device (the second switch device 14) calculated by the traffic bypass unit 132 explained below is recorded.

Referring back to FIG. 2, when a traffic amount per effective communication port in the own device is larger, by a threshold or more, than a traffic amount per effective communication port in the other network relay device (the second switch device 14) in each of the link-aggregation groups, the traffic bypass unit 132 transmits traffic of the link-aggregation group to the other network relay device via the bridge port BP. That is, the traffic bypass unit 132 bypasses a part of the traffic to the second switch device 14.

Such unbalance of the traffic occurs, for example, when there is a counter device connected to only one of the switch devices 12 and 14 besides when there is a failure of the communication port.

For example, when numerical values shown in FIG. 3 are referred to as an example, a traffic amount of MC-LAG1 is 6 Gbps, the number of effective communication ports is one, and a traffic amount per effective communication port is 6 Gbps in the first switch device 12. A traffic amount of MC-LAG1 is 6 Gbps, the number of effective communication ports is two, and a traffic amount per effective communication port is 3 Gbps in the second switch device 14.

Accordingly, the traffic amount per effective communication port in the first switch device 12 is a double of the traffic amount per effective communication port in the second switch device 14. It is seen that the first switch device 12 is in a state in which congestion easily occurs.

In this embodiment, the traffic bypass unit 132 calculates an apportion ratio for traffic such that traffic amounts per effective communication port in the switch devices 12 and 14 become uniform.

The apportion ratio is calculated by, for example, the following Expression (1). Note that, in the expression, “MC-LAG” indicates a multi-chassis link-aggregation group and “SW” indicates a switch device.

Apportion ratio={(total traffic amount of MC-LAG+number of effective ports of entire MC-LAG)×number of effective ports of SW−traffic amount of SW}÷total traffic amount of MC-LAG (1)

An apportion ratio is calculated as follows with reference to the numerical values shown in FIG. 3 as an example.

Apportion ratio from the first switch device 12={(12÷3)×1−6}÷12=−1/6(≈−16%)

Apportion ratio from the second switch device 14={(12÷3)×2−6}÷12=1/6(≈+16%)

The negative apportion ratio indicates that a traffic amount of the own device is larger than a traffic amount of the other device and indicates that a traffic amount per effective communication port can be made uniform by bypassing traffic corresponding to the apportion ratio to the other device (subtracting the traffic). The positive apportion ratio indicates that the traffic amount of the own device is smaller than the traffic amount of the other device and indicates that the traffic amount per effective communication port can be made uniform by receiving traffic corresponding to the apportion ratio from the other device (adding the traffic).

Accordingly, in the example explained above, the traffic amount per effective communication port can be made uniform by bypassing the traffic from the first switch device 12 to the second switch device 14 by approximately 16%.

That is, the traffic bypass unit 132 calculates a traffic distribution amount per effective communication port by dividing a traffic total amount in the same link-aggregation group by a total number of effective communication ports in the link-aggregation group. The traffic bypass unit 132 then determines a traffic amount transmitted to the other network relay device (the second switch device 14) by dividing a difference between a traffic amount obtained by multiplying together the traffic distribution amount and the number of effective communication ports of the own device and an actual traffic amount in the own device by the traffic total amount.

Note that, if the difference between the traffic amount per effective communication port in the own device and the traffic amount per effective communication port in the other network relay device (the second switch device 14) is small, since an effect of bypassing is low (a congestion state is unlikely), the bypassing of the traffic may not be performed.

In this embodiment, a threshold is set for the absolute value of the apportion ratio. The bypassing is not performed, for example, when the absolute value of the apportion ratio is smaller than 10%. For example, in MC-LAG3 shown in FIG. 3, since the apportion ratio calculated based on Expression (1) describe above is nearly zero, the traffic bypass unit 132 does not perform the bypassing of the traffic.

Note that the threshold may be set to “0%” or the like and the bypassing to the other device may always be performed when unbalance of the traffic occurs.

The traffic bypass unit 132 gives, to traffic transmitted to the other relay device (the second switch device 14) via the bridge port BP (hereinafter referred to as “bypass traffic”), an identifier of a multi-chassis link-aggregation group set for a communication port that receives the traffic (hereinafter referred to as “reception group identifier”). For example, a reception group identifier of traffic received by the reception port RP1 or RP2 of the first switch device 12 is “MC-LAG1”.

This is to specify a transmission destination of the bypass traffic on the second switch device 14 side that receives the bypass traffic from the first switch device 12. Note that the bypass traffic transmitted from the traffic bypass unit 132 of the first switch device 12 is processed by the bypass-traffic process unit 134 on the second switch device 14 side.

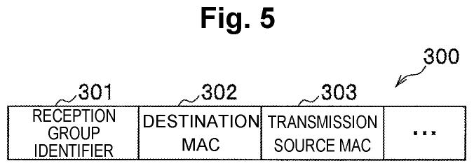

FIG. 5 is a diagram schematically showing a header portion of the bypass traffic.

In a frame 300 to be the bypass traffic, a reception group identifier 301, which is an identifier of a multi-chassis link-aggregation group set for the reception port RP when the frame is received by the first switch device 12, is given to the head of the header portion.

A header of original traffic includes a MAC address (a destination MAC address) 302 of a device to be a transmission destination of a frame and a MAC address (a transmission source MAC address) 303 of a device at a transmission source.

Referring back to FIG. 2, when receiving traffic from the other network relay device (the second switch device 14) via the bridge port BP, the bypass-traffic process unit 134 transmits the traffic from a communication port (the transmission port SP1 or SP2) connected to a counter device to be a transmission destination of the traffic.

The bypass-traffic process unit 134 transmits the traffic to a communication port other than a communication port in which a link-aggregation group specified by a reception group identifier attached to the traffic is set. When transmitting bypass traffic, the bypass-traffic process unit 134 removes the reception group identifier 301 (see FIG. 5) attached to a header of the bypass traffic and returns the bypass traffic to the same header configuration as the configuration of normal traffic.

For example, a case in which a link connected to the transmission port SP1 of the first switch device 12 is out of order as shown in FIG. 4 is explained as an example. The traffic bypass unit 132 of the first switch device 12 gives “MC-LAG1”, which is an identifier of a multi-chassis link-aggregation group set for the reception port RP (RP1 or RP2) that receives the frame, to the header of the bypass traffic and transfers the bypass traffic to the second switch device 14.

The bypass-traffic process unit 134 of the second switch device 14 selects, based on “MC-LAG1” attached to the header of the received bypass traffic, a communication port set as a transmission destination of the frame.

Specifically, the bypass-traffic process unit 134 transmits the bypass traffic from a port other than the reception ports RP (RP1 and RP2) of the own device (the second switch device 14) in which “MC-LAG1” is set, that is, the transmission port SP1 or SP2 to the second counter device 18.

Subsequently, a processing flow of the switch devices 12 and 14 is explained. A flowchart referred to below is explained with reference to a processing flow of traffic received by the first switch device 12 from the first counter device 16 as an example.

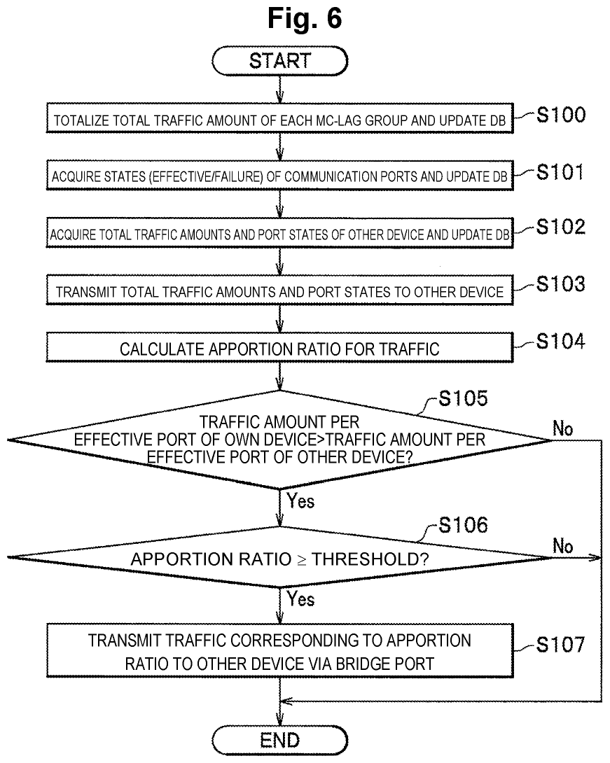

FIG. 6 is a flowchart showing a procedure of reception traffic processing by a switch device.

The traffic totalization unit 124 of the first switch device 12 totalizes a total traffic amount received by the multi-chassis link-aggregation group set for the own device and updates the traffic amount information 1305 (see FIG. 3) of the state management database 130 (in FIG. 6, simply described as “DB”) (step S100).

The failure detection unit 126 detects a state (effective or failure) of each of communication ports of the own device and updates the operation state information 1304 of the state management database 130 (step S101).

The other-device-information acquisition unit 128 acquires a total traffic amount for each of the multi-chassis link-aggregation groups and an operation state of the communication ports of the second switch device 14 (the other device) and updates the traffic amount information 1305 and the operation state information 1304 (fields of the second switch device 14) of the state management database 130 (step S102).

When receiving an acquisition request for the total traffic amount for each of the multi-chassis link-aggregate groups and the operation state of the communication ports from the other-device-information acquisition unit 128 of the second switch device 14, the first switch device 12 transmits the relevant information to the second switch device 14 (step S103).

Subsequently, the traffic bypass unit 132 calculates an apportion ratio for traffic using the information of the state management database 130 (step S104).

The traffic bypass unit 132 compares a transmission traffic amount per effective communication port (in FIG. 6, described as “effective port”) in the own device and a transmission traffic amount per effective communication port in the second switch device 14 (step S105).

When the transmission traffic amount per effective communication port in the own device is equal to or smaller than the transmission traffic amount per effective communication port in the second switch device 14 (step S105: No), since it is unnecessary to bypass the traffic from the own device, the first switch device 12 ends the processing of this flowchart.

On the other hand, when the transmission traffic amount per effective communication port in the own device is larger than the transmission traffic amount per effective communication port in the second switch device 14 (step S105: Yes), the traffic bypass unit 132 determines whether the apportion ratio calculated in step S104 is equal to or larger than a threshold (for example, 10%) (step S106).

When the apportion ratio is equal to or larger than the threshold (step S106: Yes), the traffic bypass unit 132 transmits traffic corresponding to the apportion ratio to the second switch device 14 via the bridge port BP (step S107) and ends the processing of this flowchart.

At this time, the traffic bypass unit 132 gives a reception group identifier of the traffic to the header of the bypass traffic.

On the other hand, when the apportion ratio is smaller than the threshold (step S106: No), since an effect is small even if the traffic is bypassed, bypassing of the traffic is not performed. The first switch device 12 directly ends the processing of this flowchart.

Subsequently, processing on a switch device side that receives bypass traffic is explained.

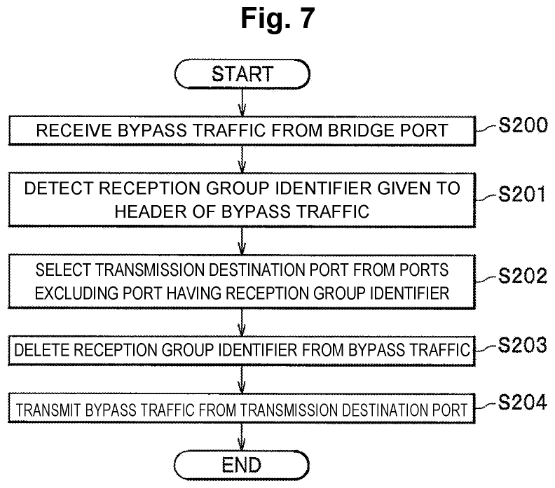

FIG. 7 is a flowchart showing a procedure of bypass traffic processing by the switch device.

The bypass-traffic process unit 134 of the second switch device 14 receives bypass traffic from the first switch device 12 via the bridge port BP (step S200).

Subsequently, the bypass-traffic process unit 134 detects a reception group identifier given to a header of the bypass traffic (step S201) and selects a port set as a transmission destination of the bypass traffic (a transmission destination port) from communication ports other than a communication port in which a multi-chassis link-aggregation group identified by the reception group identifier is set (step S202).

The bypass-traffic process unit 134 deletes the reception group identifier given to the header of the bypass traffic (step S203) and, then, transmits the bypass traffic from the transmission destination port selected in step S202 (step S204) and ends the processing of this flowchart.

<Hardware Configuration>

Subsequently, a hardware configuration of the switch devices 12 and 14, which are the network relay devices, is explained.

The switch devices 12 and 14 according to this embodiment are realized by, for example, a switch device 600 having a configuration shown in FIG. 8.

FIG. 8 is a diagram showing an example of the hardware configuration of the switch devices 12 and 14 according to this embodiment. The switch device 600 includes a CPU (Central Processing Unit) 601, a ROM (Read Only Memory) 602, a RAM 603, an HDD (Hard Disk Drive) 604, ports 605, and an ASIC 606.

The CPU 601 operates based on a program stored in the ROM 602 or the HDD 604. The ROM 602 stores a boot program to be executed by the CPU 601 at a start time of the switch device 600, a program relating to hardware of the switch device 600, and the like.

The HDD 604 stores a program to be executed by the CPU 601 and data and the like used by the program.

The ports 605 include the reception port RP, the transmission port SP, and the bridge port BP explained above. Communication lines for transmitting and receiving data to and from the other devices (for example, counter devices) are connected to the ports 605.

The ASIC 606 realizes transfer of data between any ports.

For example, when the switch device 600 functions as the switch devices 12 and 14 of the present invention, the CPU 601 of the switch device 600 realizes the functions of the switch devices 12 and 14 by executing a program loaded onto the RAM 603. Data in the RAM 603 is stored in the HDD 604. The CPU 601 reads a program relating to target processing from the ROM 602 or the HDD 604 and executes the program.

<Effects>

Effects of the communication system according to the present invention is explained below.

The communication system according to the present invention is the communication system 10 including the counter devices 16 and 18 forming a pair and the plurality of network relay devices (the switch devices 12 and 14) connecting the counter devices 16 and 18. Each of the switch devices 12 and 14 includes the plurality of communication ports (the reception ports RP1 and RP2 and the transmission ports SP1 and SP2) provided for each of the counter devices 16 and 18 and connecting the own device (the own switch device) and the counter devices 16 and 18, the bridge port BP connected to the other switch device, the traffic totalization unit 124 that totalizes, for each of the multi-chassis link-aggregation groups set for the communication ports, a traffic amount received by the communication ports of the own device, the failure detection unit 126 that detects whether the communication port of the own device to be a transmission destination of traffic of the multi-chassis link-aggregation group is effective, the other-device-information acquisition unit 128 that acquires a traffic amount for each of the multi-chassis link-aggregation groups in the other switch device and information concerning whether the communication port of the other switch device is effective, and the traffic bypass unit 132 that transmits a part of the traffic of the multi-chassis link-aggregation group to the other switch device via the bridge port BP when a traffic amount per effective communication port in the own device is larger than a traffic amount per effective communication port in the other switch device by the threshold or more in the multi-chassis link-aggregation group.

In this way, the network relay devices (the switch devices 12 and 14) compare, about the traffic in the multi-chassis link-aggregation group, the traffic amount per effective communication port in the own device and the traffic amount per effective communication port in the other switch device and, when the traffic amount of the own device is larger by the threshold or more, bypasses a part of the traffic to the other switch device via the bridge port BP.

Accordingly, for example, when a part of the communication ports of the switch devices 12 and 14 fails, it is possible to avoid traffic concentrating on the communication port without a failure of the switch device and suppress occurrence of congestion. For example, when the counter device connected to only one of the switch devices 12 and 14 is present as shown in FIG. 12, traffic transmitted from the counter device can also be transmitted to a transmission destination counter device from the other switch device. It is possible to more effectively use resources of the communication system 10.

The switch devices 12 and 14 do not perform bypassing of the traffic when the difference between the traffic amounts of the own device and the other switch device is small (equal to or smaller than the threshold). Therefore, it is possible to avoid unnecessary bypassing (having a limited effect) and improve processing efficiency of the communication system 10.

In the communication system 10, the traffic bypass unit 132 calculates a traffic distribution amount per effective communication port by dividing a traffic total amount in the same multi-chassis link-aggregation group by a total number of the effective communication ports in the multi-chassis link-aggregation group and determines a traffic amount transmitted to the other switch device by dividing a difference between a traffic amount obtained by multiplying together the traffic distribution amount and the number of effective communication ports of the own device and an actual traffic amount in the own device by the traffic total amount.

Consequently, the network relay devices (the switch devices 12 and 14) can make uniform transmission traffic amounts from the communication ports in which the same multi-chassis link-aggregation group is set and more surely prevent congestion.

In the communication system 10, each of the switch devices 12 and 14 further includes the bypass-traffic process unit 134 that transmits, when receiving traffic from the other switch device via the bridge port BP, the traffic from the communication port of the own device connected to the counter device to be a transmission destination of the traffic. The traffic bypass unit 132 gives, to the traffic to be transmitted, an identifier of the multi-chassis link-aggregation group set for the communication port that receives the traffic. The bypass-traffic process unit 134 transmits the traffic from the communication port other than the communication port in which the multi-chassis link-aggregation group specified by the identifier is set.

Consequently, it is possible to avoid traffic being returned to a counter device at a transmission source of the traffic (avoid a loop occurring) and improve processing efficiency of the communication system 10.

Note that the present invention is not limited to the embodiment explained above. A lot of modifications are possible by those having ordinary knowledge in the field within the technical idea of the present invention.

### REFERENCE SIGNS LIST

10 Communication system
12 First switch device (network relay device)
14 Second switch device (network relay device)
16 First counter device
18 Second counter device
120 Switch unit
122 Monitor control unit
124 Traffic totalization unit
126 Failure detection unit
128 Other-device-information acquisition unit
130 State management database
132 Traffic bypass unit
136 Bypass-traffic process unit
BP Bridge port
RP (RP1, RP2) Reception port
SP (SP1, SP2) Transmission port

1. A communication system comprising:
counter devices forming a pair; and
a plurality of network relay devices connecting the counter devices, wherein each of the network relay devices includes:
a plurality of communication ports provided for each of the counter devices and connecting the network relay device and the counter device;
a bridge port connected to another network relay device;
a processor configured to:
totalize, for each of multi-chassis link-aggregation groups set for the communication ports, a traffic amount received by the communication ports of the network relay device;
detect whether the communication port of the network relay device to be a transmission destination of traffic of the multi-chassis link-aggregation group is effective; and
acquire a traffic amount for each of multi-chassis link-aggregation groups in the other network relay device and information concerning whether the communication port of the other network relay device is effective; and
a transmitter that transmits a part of the traffic of the multi-chassis link-aggregation group to the other network relay device via the bridge port when a traffic amount per effective communication port in the network relay device is larger than the traffic amount per the effective communication port in the other network relay device by a threshold or more in the multi-chassis link-aggregation group.

2. The communication system according to claim 1, wherein the processor is configured to control the transmitter to calculate a traffic distribution amount per the effective communication port by dividing a traffic total amount in the same multi-chassis link-aggregation group by a total number of the effective communication ports in the multi-chassis link-aggregation group and determines a traffic amount transmitted to the other network relay device by dividing a difference between a traffic amount obtained by multiplying together the traffic distribution amount and the number of the effective communication ports of the network relay device and an actual traffic amount in the network relay device by the traffic total amount.

3. The communication system according to claim 1, wherein
the processor of each of the network relay devices is further configured to:
control the transmitter to transmit, when receiving traffic from the other network relay device via the bridge port, the traffic from the communication port of the network relay device connected to the counter device to be a transmission destination of the traffic,
give, to the traffic to be transmitted, an identifier of a multi-chassis link-aggregation group set for the communication port that receives the traffic, and
control the transmitter to transmit the traffic from a communication port other than the communication port in which the multi-chassis link-aggregation group specified by the identifier is set.

4. A network relay device that constructs, in conjunction with another network relay device, multi-chassis link-aggregation connecting counter devices forming a pair, the network relay device comprising:
a plurality of communication ports provided for each of the counter devices and connecting the network relay device and the counter device;
a bridge port connected to the other network relay device;
a processor configured to:
totalize, for each of multi-chassis link-aggregation groups set for the communication ports, a traffic amount received by the communication ports of the network relay device;
detect whether the communication port of the network relay device to be a transmission destination of traffic of the multi-chassis link-aggregation group is effective; and
acquire a traffic amount for each of multi-chassis link-aggregation groups in the other network relay device and information concerning whether the communication port of the other network relay device is effective; and
a transmitter that transmits a part of the traffic of the multi-chassis link-aggregation group to the other network relay device via the bridge port when a traffic amount per effective communication port in the network relay device is larger than the traffic amount per the effective communication port in the other network relay device by a threshold or more in the multi-chassis link-aggregation group.

5. A network relay method for a network relay device that constructs, in conjunction with another network relay device, multi-chassis link-aggregation connecting counter devices forming a pair, the network relay method comprising:
connecting, by a plurality of communication ports provided for each of the counter devices, the network relay device and the counter device;
connecting, by a bridge port, the network relay device to the other network relay device;
totalizing, for each of multi-chassis link-aggregation groups set for the communication ports, a traffic amount received by the communication ports of the network relay device;
detecting whether the communication port of the network relay device to be a transmission destination of traffic of the multi-chassis link-aggregation group is effective;
acquiring a traffic amount for each of multi-chassis link-aggregation groups in the other network relay device and information concerning whether the communication port of the other network relay device is effective; and
transmitting a part of the traffic of the multi-chassis link-aggregation group to the other network relay device via the bridge port when a traffic amount per effective communication port in the network relay device is larger than the traffic amount per the effective communication port in the other network relay device by a threshold or more in the multi-chassis link-aggregation group.

6. (canceled)
